(19) United States
(12) Patent Application Publication
(10) Pub. No.: US 2026/0036672 A1
(43) Pub. Date: Feb. 5, 2026

(54) RADAR DEVICE AND OPERATING METHOD OF RADAR DEVICE

(71) Applicant: ELECTRONICS AND TELECOMMUNICATIONS RESEARCH INSTITUTE, Daejeon (KR)

(72) Inventors: Yi-Gyeong KIM, Daejeon (KR); Kyung Hwan PARK, Daejeon (KR); Young-deuk JEON, Daejeon (KR); MIN-HYUNG CHO, Daejeon (KR)

(21) Appl. No.: 19/248,609

(22) Filed: Jun. 25, 2025

(30) Foreign Application Priority Data
Jul. 31, 2024 (KR) 10-2024-0101782
Nov. 21, 2024 (KR) 10-2024-0167139

(51) Int. Cl. G01S 7/292; G01S 7/295; G01S 13/00; G01S 13/18

(52) U.S. Cl. CPC G01S 7/2922; G01S 7/295; G01S 13/006; G01S 13/18

(57) ABSTRACT

A radar device is disclosed. The radar device includes a transmitting unit that radiates a transmission pulse, and a receiving unit that receives an echo pulse reflected from a target object. The receiving unit includes a multi-receiving circuit AFE including a plurality of receiving circuits that amplifies an echo pulse to output an amplified signal and an analog signal summing circuit that generates a summed signal, a sampling circuit that repeatedly performs a sampling operation on the summed signal to generate a plurality of sampling data, a signal integrator that generates integrated data for each of range cells, a statistical signal converter that acquires noise statistical data and generates an extracted signal, and an AFE controller that performs a characteristic verification operation for the noise statistical data and adjusts the summed signal.

### CROSS-REFERENCE TO RELATED APPLICATIONS

This application claims priority under 35 U.S.C. § 119 to Korean Patent Application Nos. 10-2024-0101782 filed on Jul. 31, 2024, and 10-2024-0167139 filed on Nov. 21, 2024, in the Korean Intellectual Property Office, the disclosures of which are incorporated by reference herein in their entireties.

### BACKGROUND

### 1. Field of the Invention

Embodiments of the present disclosure herein relate to a radar device, and more particularly, relate to a radar device and a method of operating the radar device that extracts a signal using a statistical distribution of noise.

### 2. Description of Related Art

A radar device that uses a pulse as a transmission signal repeatedly transmits a transmission pulse. A receiving unit of the radar device receives an echo pulse in which the transmission pulse is reflected from the target object, and obtains information of the target object.

The echo pulse includes a target signal reflected from the target object, a clutter signal reflected from an object surrounding the target object, and noise. The radar device extracts the target signal from the echo pulse including the target signal, the clutter signal, and the noise. However, when the target signal, the clutter signal, and the noise are not distinguished, it may be difficult to extract the target signal from the echo pulse.

In addition, the magnitude of the echo pulse may be weak depending on the distance relative to the transmission pulse, the size, shape, material, and the like of the target object. In this case, the signal-to-noise ratio at the receiving unit of the radar device may be reduced, it may be difficult to extract the target signal.

Therefore, there is required a method for preserving magnitude information of the target signal included in the echo pulse, and distinguishing the target signal from the clutter signal and the noise.

### SUMMARY OF THE INVENTION

Embodiments of the present disclosure provide a radar device and a method of operating the radar device that extracts a signal using a statistical distribution of noise, in order to preserve magnitude information of a target signal and distinguish the target signal from a clutter signal and the noise.

According to an embodiment of the present disclosure, a radar device includes a transmitting unit that radiates a transmission pulse, and a receiving unit that receives an echo pulse reflected from a target object. The receiving unit includes a multi-receiving circuit AFE including a plurality of receiving circuits that amplifies an echo pulse to output an amplified signal and an analog signal summing circuit that generates a summed signal based on the amplified signals, a sampling circuit that repeatedly performs a sampling operation on the summed signal to generate a plurality of sampling data, a signal integrator that generates integrated data for each of range cells based on the plurality of sampling data, a statistical signal converter that acquires noise statistical data based on the integrated data and generates an extracted signal based on the noise statistical data, and an AFE controller that performs a characteristic verification operation for the noise statistical data and adjusts the summed signal based on a result of the characteristic verification operation.

According to an embodiment of the present disclosure, the characteristic verification operation includes a saturation verification operation and a magnitude verification operation on the noise statistical data.

According to an embodiment of the present disclosure, the AFE controller outputs a first AFE control signal when it is determined, as a result of the saturation verification operation, that a saturation range cell is present. The multi-receiving circuit AFE reduces a number of signals being summed into the summed signal based on the first AFE control signal.

According to an embodiment of the present disclosure, the AFE controller performs the magnitude verification operation when it is determined, as the result of the saturation verification operation, that the saturation range cell is not present, and outputs a second AFE control signal when it is determined, as a result of the magnitude verification operation, that a maximum signal magnitude is equal to or less than a threshold value. The multi-receiving circuit AFE increases the number of signals being summed into the summed signal base on the second AFE control signal.

According to an embodiment of the present disclosure, the sampling circuit includes a comparator that samples the summed signal based on a reference voltage. Each of the plurality of sampling data includes a sampling value for each of the range cells. The sampling value is associated with the reference voltage.

According to an embodiment of the present disclosure, the sampling circuit includes a multi-level ADC that samples the summed signal based on a plurality of reference voltages. Each of the plurality of sampling data includes sampling values for each of range cells. The sampling values are respectively associated with the plurality of reference voltage.

According to an embodiment of the present disclosure, the analog signal summing circuit selects at least a portion of the amplified signals, and sums the at least the portion of the amplified signals to generate the summed signal. The AFE controller outputs an AFE control signal for adjusting the summed signal. The analog signal summing circuit adjusts the number of the at least the portion of the amplified signals based on the AFE control signal.

According to an embodiment of the present disclosure, the AFE controller outputs an AFE control signal for adjusting the summed signal. A number of amplified signals is adjusted based on the AFE control signal.

According to an embodiment of the present disclosure, the multi-receiving circuit AFE includes a plurality of receiving antennas. Each of the plurality of receiving antennas is respectively connected to the plurality of receiving circuits and receives the echo pulse.

According to an embodiment of the present disclosure, the multi-receiving circuit AFE includes a common receiving antenna. The common receiving antenna is connected to the plurality of receiving circuits and receives the echo pulse.

According to an embodiment of the present disclosure, a method of operating a radar device for receiving an echo pulse via a plurality of receiving circuits includes amplifying the echo pulse to output a plurality of amplified signals, generating a summed signal based on the plurality of amplified signals, performing a sampling operation on the summed signal repeatedly to generate a plurality of sampling data, generating integrated data for each of range cells based on the plurality of sampling data, acquiring noise statistical data based on the integrated data, performing a characteristic verification operation on the noise statistical data, and adjusting a number of signals being summed into the summed signal based upon a result of the characteristic verification operation.

According to an embodiment of the present disclosure, the performing of the characteristic verification operation on the noise statistical data includes performing a saturation verification operation on the noise statistical data, and performing a magnitude verification operation on the noise statistical data when it is determined, as a result of the saturation verification operation, that a saturation range cell is not present.

According to an embodiment of the present disclosure, the adjusting of the number of signals being summed into the summed signal includes decreasing the number of signals being summed into the summed signal when it is determined, as the result of the saturation verification operation, that a saturation range cell is present.

According to an embodiment of the present disclosure, the adjusting of the number of signals being summed into the summed signal includes increasing the number of signals being summed into the summed signal when it is determined, as a result of the magnitude verification operation, that a maximum signal magnitude is equal to or less than a threshold value.

According to an embodiment of the present disclosure, the sampling operation is performed based on a reference voltage. Each of the plurality of sampling data includes a sampling value for each of the range cells. The sampling value is associated with the reference voltage.

According to an embodiment of the present disclosure, the sampling operation is performed based on a plurality of reference voltages. Each of the plurality of sampling data includes sampling values for each of range cells. The sampling values are respectively associated with the plurality of reference voltage.

According to an embodiment of the present disclosure, the generating of the summed signal based on the plurality of amplified signals includes selecting at least a portion of the plurality of amplified signal, and summing the at least the portion of the plurality of amplified signals to generate the summed signal. The adjusting of the number of signals being summed into the summed signal includes adjusting the number of the at least the portion of the plurality of amplified signals.

According to an embodiment of the present disclosure, the adjusting of the number of signals being summed into the summed signal includes adjusting the number of the plurality of amplified signals being output.

According to an embodiment of the present disclosure, the method further includes generating an extracted signal using the noise statistical data based on the result of the characteristic verification operation.

According to an embodiment of the present disclosure, the radar device receives the echo pulse via at least one of receiving antennas.

### BRIEF DESCRIPTION OF THE DRAWINGS

The above and other objects and features of the present disclosure will become apparent by describing in detail embodiments thereof with reference to the accompanying drawings.

FIG. 1 illustrates a radar device, according to an embodiment of the present disclosure.

FIG. 2 illustrates a receiving unit of a radar device, according to an embodiment of the disclosure.

FIG. 3 illustrates a receiving unit of a radar device, according to an embodiment of the disclosure.

FIG. 4 illustrates noise statistical data, according to an embodiment of the present disclosure.

FIG. 5 illustrates an example of a received signal that is received by a radar device.

FIG. 6 illustrates an example of an extracted signal that is extracted by a radar device.

FIG. 7 illustrates an example of adjusting characteristics of noise statistical data, according to an embodiment of the present disclosure.

FIG. 8 illustrates a method of operating a radar device, according to an embodiment of the present disclosure.

FIG. 9 illustrates an example of a characteristic verification operation, according to an embodiment of the present disclosure.

FIGS. 10A and 10B illustrate examples of a saturation verification operation, according to an embodiment of the present disclosure.

FIGS. 11A and 11B illustrate examples of a magnitude verification operation, according to an embodiment of the present disclosure.

FIG. 12 illustrates a receiving unit of a radar device, according to an embodiment of the present disclosure.

FIG. 13 illustrates noise statistical data, according to an embodiment of the present disclosure.

FIG. 14 illustrates a receiving unit of a radar device, according to an embodiment of the present disclosure.

FIG. 15 illustrates a receiving unit of a radar device, according to an embodiment of the present disclosure.

### DETAILED DESCRIPTION OF THE INVENTION

Hereinafter, embodiments of the present disclosure may be described in detail and clearly to such an extent that an ordinary one in the art easily implements the present disclosure.

Components that are described in the detailed description with reference to the terms “unit”, “module” “block” “˜er or ˜or”, etc. and function blocks illustrated in drawings will be implemented with software, hardware, or a combination thereof. For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

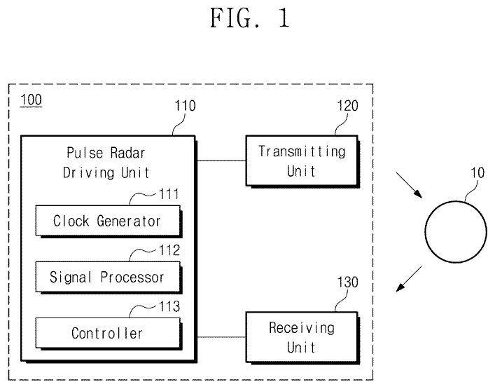

FIG. 1 illustrates a radar device, according to an embodiment of the present disclosure. Referring to FIG. 1, a radar device 100 may include a pulse radar driving unit 110, a transmitting unit 120, and a receiving unit 130.

The pulse radar driving unit 110 may include a clock generator 111, a signal processor 112, and a controller 113. The clock generator 111 may generate clock signals. For example, the clock generator 111 may generate a transmission clock signal for radiating the transmission signal. The clock generator 111 may generate a reception clock signal for processing a received signal. However, the scope of the present disclosure is not limited thereto, and the clock generator 111 may generate various clock signals for supporting the operation of the radar device 100.

The signal processor 112 may obtain information about a target object 10 based on an extracted signal received from the receiving unit 130. For example, the signal processor 112 may calculate position information, velocity information, and the like of the target object 10 based on the extracted signal.

The controller 113 may control the overall operation of the radar device 100. For example, the controller 113 may generate various control signals and transmit the generated control signals to the transmitting unit 120 and the receiving unit 130.

The transmitting unit 120 may radiate the transmission signal toward the target object 10. For example, the transmitting unit 120 may generate the transmission signal based on the transmission clock signal. The transmitting unit 120 may radiate the transmission signal to the target object 10 via a transmitting antenna. The transmission signal may be a pulse signal.

The receiving unit 130 may receive a received signal from the target object 10. The received signal may be an echo pulse, which is a signal that is reflected from the target object 10 by the transmission signal. In an embodiment, the echo pulse may include a target signal reflected from the target object 10, a clutter signal reflected from an object surrounding the target object 10, and noise.

The receiving unit 130 may generate the extracted signal based on the received signal. For example, the receiving unit 130 may generate the extracted signal based on a statistical distribution (hereinafter, referred to as “noise statistical data”) of the noise included in the echo pulse and noise caused by the receiving unit 130. The configuration and operation of the receiving unit 130 will be described in more detail with reference to the following drawings.

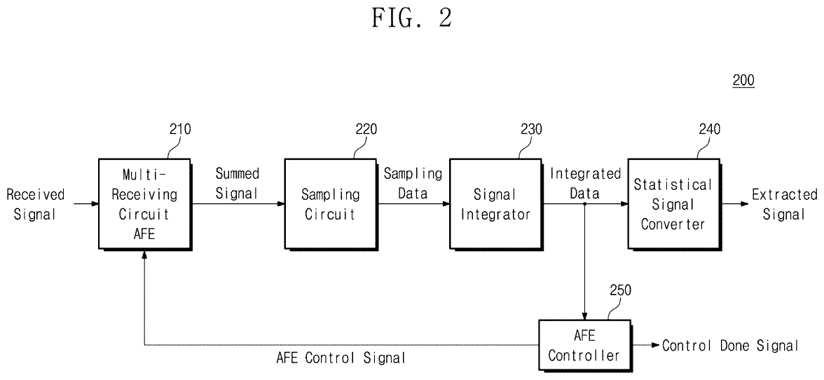

FIG. 2 illustrates a receiving unit of a radar device, according to an embodiment of the disclosure. In FIG. 2, a receiving unit 200 may correspond to the receiving unit 130 in FIG. 1.

Referring to FIGS. 1 and 2, the receiving unit 200 may include a multi-receiving circuit AFE 210, a sampling circuit 220, a signal integrator 230, a statistical signal converter 240, and an AFE controller 250.

The multi-receiving circuit AFE 210 may include a plurality of receiving circuits and an analog signal summing circuit. Each of the plurality of receiving circuits may be configured to amplify the received signal to output an amplified signal. The analog signal summing circuit may sum at least a portion of amplified signals output from the plurality of receiving circuits to generate a summed signal. The analog signal summing circuit may transmit the summed signal to the sampling circuit 220.

In an embodiment, the magnitude of the summed signal may be related to the number of amplified signals being summed. For example, when the number of amplified signals being summed increases, the magnitude of the summed signal (e.g., the magnitude of the target signal, the magnitude of the clutter signal, and the magnitude of noise) may increase.

Sampling circuit 220 may receive the summed signal. The sampling circuit 220 may perform, based on the at least one reference voltage, a sampling operation on the summed signal. As a result, the sampling circuit 220 may generate sampling data. The sampling data may include sampling values for a plurality of range cells. That is, the sampling data may include a sampling value for each of the range cells. The sampling value may be one of ‘1‘ and’0’. The sampling circuit 220 may transmit the sampling data to the signal integrator 230.

In an embodiment, the range cell may represent each time interval when the sampling time is divided by a constant time interval. That is, the range cell may refer to a time interval corresponding to a specific distance.

The sampling circuit 220 may repeatedly perform the sampling operation to generate a plurality of sampling data. For example, the sampling circuit 220 may generate a plurality of sampling data as many times as the sampling operation is performed.

In an embodiment, the sampling value may be associated with a reference voltage. For example, the sampling value may have one of “1” and “0” according to a result of comparing the magnitude of the signal included in an arbitrary range cell and the magnitude of the reference voltage.

In an embodiment, the sampling circuit 220 may receive a first clock signal from the pulse radar driving unit 110. The sampling circuit 220 may perform a sampling operation based on the first clock signal.

In an embodiment, the sampling circuit 220 may receive at least one reference voltage from the pulse radar driving unit 110.

The signal integrator 230 may receive the plurality of sampling data from the sampling circuit 220. The signal integrator 230 may generate a plurality of integrated data for the range cells based on the plurality of sampling data. That is, the signal integrator 230 may generate integrated data for each of the range cells based on a plurality of sampling data. The signal integrator 230 may store and output the integrated data.

The integrated data may include sampling count information and integration values Nn and Np for each of the range cells. The integration values Nn and Np may represent a result of accumulating the sampling values for each of the range cells included in the plurality of sampling data. For example, a first integration value Nn may represent the number of sampling values having a value of ‘0’, and a second integration value Np may represent the number the sampling values having the value of ‘1’.

In an embodiment, the signal integrator 230 may receive a second clock signal from the pulse radar driving unit 110. The signal integrator 230 may operate based on the second clock signal.

In an embodiment, the signal integrator 230 may receive a control signal from the pulse radar driving unit 110 to reset the stored integrated data. After the reset, the signal integrator 230 may generate and store new integrated data.

The statistical signal converter 240 may receive the plurality of integrated data from the signal integrator 230. The statistical signal converter 240 may acquire a plurality of noise statistical data for the range cells based on the plurality of integrated data. That is, the statistical signal converter 240 may acquire the noise statistical data for each of the range cells based on the integrated data for each of the range cells.

The statistical signal converter 240 may generate an extracted signal based on the plurality of noise statistical data. The extracted signal may include magnitude information of a signal included in each of the range cells.

The AFE controller 250 may receive the plurality of integrated data output from the signal integrator 230. The AFE controller 250 may perform a characteristic verification operation on each of the plurality of integrated data.

If a result of the characteristic verification operation is a ‘fail’, the AFE controller 250 may output an AFE control signal to control the multi-receiving circuit AFE 210. The multi-receiving circuit AFE 210 may adjust the summed signal based on the AFE control signal. In an embodiment, if a range cell including a saturated signal is present among the range cells (hereinafter referred to as a ‘saturation range cell’) or if a maximum signal magnitude among signals included in the range cells is equal to or less than a threshold value, the result of the characteristic verification operation may be determined to be ‘fail’.

If the result of the characteristic verification operation is a ‘pass’, the AFE controller 250 may output a control done signal. In an embodiment, the AFE controller 250 may transmit the control done signal to the pulse radar driving unit 110. In this case, the pulse radar driving unit 110 may transmit a control signal for generating the extracted signal from the noise statistical data to the statistical signal converter 240 based on the control done signal. In an embodiment, if the saturation range cell is not present among the range cells and the maximum signal magnitude among the signals included in the range cells is greater than the threshold value, the result of the characteristic verification operation may be determined to be a ‘pass’.

In an embodiment, the AFE controller 250 may transmit the control done signal to the statistical signal converter 240. At this time, the statistical signal converter 240 may generate the extracted signal from the noise statistical data based on the control done signal.

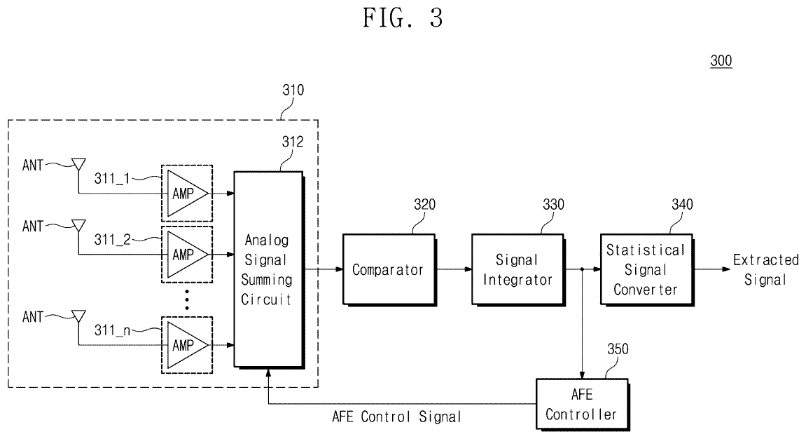

FIG. 3 illustrates a receiving unit of a radar device, according to an embodiment of the disclosure. Referring to FIG. 3, the receiving unit 300 may include a multi-receiving circuit AFE 310, a comparator 320, a signal integrator 330, a statistical signal converter 340, and an AFE controller 350.

In FIG. 3, signal integrator 330, statistical signal converter 340 and AFE controller 350 may correspond to signal integrator 230, statistical signal converter 240 and AFE controller 250 of FIG. 2, respectively. Therefore, redundant description is omitted for convenience of description.

The multi-receiving circuit AFE 310 may include a plurality of receiving circuits 311_1 to 311_n (where n is a natural number greater than 1) and an analog signal summing circuit 312.

Each of the plurality of receiving circuits 311_1 to 311_n may include an amplifier (AMP). Each of the plurality of receiving circuits 311_1 to 311_n may receive a received signal via the receiving antenna (ANT). Each of the plurality of receiving circuits 311_1 to 311_n may amplify the received signal by using an amplifier AMP to generate an amplified signal. Each of the plurality of receiving circuits 311_1 to 311_n may transmit the generated amplified signal to the analog signal summing circuit 312.

The analog signal summing circuit 312 may sum at least a portion of the amplified signals output from the plurality of receiving circuits 311_1 to 311_n to generate a summed signal. For example, the analog signal summing circuit 312 may select at least a portion of the amplified signals output from the plurality of receiving circuits 311_1 to 311_n. The analog signal summing circuit 312 may sum the selected signals to generate the summed signal. The analog signal summing circuit 312 may transmit the summed signal to the comparator 320.

The analog signal summing circuit 312 may receive an AFE control signal from the AFE controller 350. The analog signal summing circuit 312 may adjust the number of signals summed to the summation signal based on the AFE control signal. For example, the analog signal summing circuit 312 may adjust the number of the selected at least some of the amplification signals based on the AFE control signal.

The comparator 320 may perform a sampling operation on the summed signal based on a reference voltage. As a result, the comparator 320 may generate sampling data. The sampling data may include sampling values for a plurality of range cells. That is, the sampling data may include a sampling value for each of the range cells. The comparator 320 may transmit the sampling data to the signal integrator 330.

The comparator 320 may repeatedly perform the sampling operation to generate a plurality of sampling data. For example, the comparator 320 may generate the plurality of sampling data as many times as the sampling operation is performed.

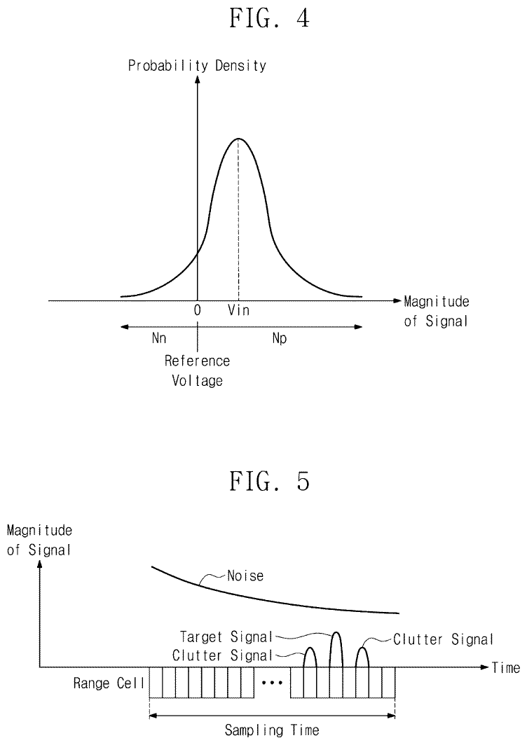

FIG. 4 illustrates noise statistical data, according to an embodiment of the present disclosure. In FIG. 4, the noise statistical data for an arbitrary range cell may be represented by a graph of a probability density function. In FIG. 4, the horizontal axis represents magnitude of a signal, and the vertical axis represents probability density.

Referring to FIGS. 3 and 4, a noise statistics graph may be acquired by accumulating sampling values for the arbitrary range cell included in a plurality of sampling data. That is, the noise statistic graph may be acquired based on a first integration value Nn and a second integration value Np included in integrated data for the arbitrary range cell.

The noise statistic graph may have the form of a Gaussian distribution. In the noise statistic graph, the magnitude of a reference voltage may be represented as ‘0’. In the noise statistics graph, the magnitude of a signal included in the arbitrary range cell may be represented by ‘Vin’. In this case, ‘Vin’ may correspond to a mean value of the noise statistic graph. That is, the mean value of the noise statistic graph may be shifted horizontally by an amount corresponding to the magnitude of the signal included in the arbitrary range cell, with respect to the magnitude of the reference voltage. The statistical signal converter 340 may extract magnitude information of the signal included in the arbitrary range cell based on the mean value of the noise statistical graph.

As described with reference to FIG. 4, the receiving unit 300 may acquire noise statistical data for each of range cells and extract magnitude information of a signal included in each of the range cells based on the noise statistical data.

FIG. 5 illustrates an example of a received signal that is received by a radar device. In FIG. 5, the horizontal axis represents time, and the vertical axis represents magnitude of a signal.

Referring to FIGS. 3 and 5, a received signal may include a target signal, a clutter signal, and noise. In this case, extraction of the target signal included in the received signal may be difficult due to the noise. In order to facilitate extraction of the target signal included in the received signal, the receiving unit 300 may generate noise statistical data on the noise. For example, the receiving unit 300 may repeatedly perform a sampling operation during a sampling time based on the received signal. The receiving unit 300 may acquire the noise statistical data on the noise based on sampling signals generated as a result of the sampling operation. The receiving unit 300 may generate an extracted signal for distinguishing between the target signal and the clutter signal based on the noise statistical data.

FIG. 6 illustrates an example of an extracted signal that is extracted by a radar device. In FIG. 6, the horizontal axis represents time, and the vertical axis represents magnitude of a signal.

Referring to FIG. 6, an extracted signal may include magnitude information for a signal included in each of range cell. For example, a first range cell RC1 may include magnitude information for the target signal. A second range cell RC2 and a third range cell RC3 may include magnitude information for the clutter signal. In addition, all range cells may include magnitude information for the noise. In this case, the magnitude of the noise included in each of range cells may be the same.

As described in FIG. 6, magnitude information for the target signal, the clutter signal, and the noise included in the extracted signal may be distinguished from each other.

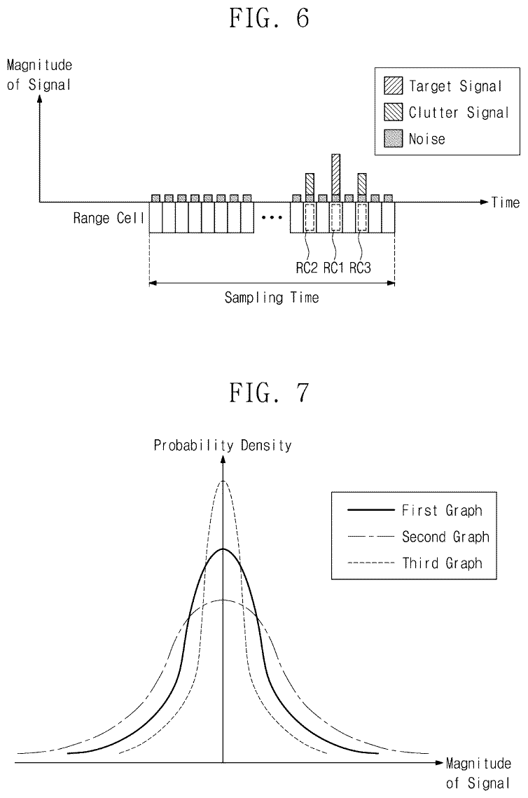

FIG. 7 illustrates an example of adjusting characteristics of noise statistical data, according to an embodiment of the present disclosure. In FIG. 7, it is assumed that a first graph is noise statistical data for a range cell in which a target signal or a clutter signal is not included, and a second graph and a third graph are noise statistical data whose characteristics are adjusted. In FIG. 7, it is assumed that the first to the third graphs are graphs of probability density functions for the noise statistical data.

Referring to FIGS. 3 and 7, the receiving unit 300 may adjust characteristics of the noise statistical data by controlling an influence of the noise on the noise statistical data. The influence of the noise on the noise statistical data may be controlled by adjusting the number of signals that are summed into the summed signal.

For example, if the number of signals being summed into the summed signal increases, the influence of the noise may increase. Accordingly, a standard deviation of the noise statistical data may increase, and a distribution of the noise statistical data may be widened. That is, the noise statistical data may change from a shape of the first graph to a shape of the second graph.

For example, if the number of signals being summed into the summed signal decreases, the influence of the noise may decrease. Accordingly, the standard deviation of the noise statistical data decreases, and the distribution of the noise statistical data may be narrowed. That is, the noise statistical data may change from the shape of the first graph to a shape of the third graph.

On the other hand, when there is no correlation of the noise of the signal, the signal-to-noise ratio (SNR) is as follows:

$$SNR = \frac{{( N \cdot m )}^{2}}{N \cdot {σ}^{2}} = \frac{N \cdot {m}^{2}}{{σ}^{2}} \qquad [ Equation 1 ]$$

In Equation 1, N represents the number of signals being summed into the summed signal, and m represents the average value of the noise statistical data based on the probability density function, σ represents the standard deviation of the noise statistical data based on the probability density function.

As described in FIG. 7, the characteristics of the noise statistical data may be adjusted based on the number of signals being summed to the summed signal.

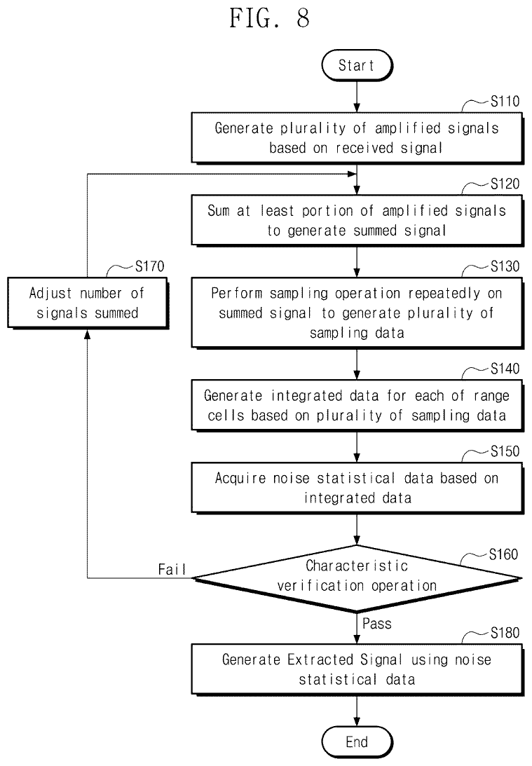

FIG. 8 illustrates a method of operating a radar device, according to an embodiment of the present disclosure. Referring to FIGS. 3 and 8, in operation S110, the receiving unit 300 may generate a plurality of amplified signals based on a received signal received from a target object. For example, each of the plurality of receiving circuits 311_1 to 311_n may amplify the received signal to output an amplified signal.

In operation S120, the receiving unit 300 may sum at least a portion of the plurality of amplified signals to generate a summed signal. For example, the analog signal summing circuit 312 may select at least a portion of the amplified signals output from the plurality of receiving circuits 311_1 to 311_n. The analog signal summing circuit 312 may sum the selected signals to generate a summed signal.

In operation S130, the receiving unit 300 may repeatedly perform a sampling operation on the summed signal to generate a plurality of sampling data. For example, the comparator 320 may repeatedly perform the sampling operation on the summed signal based on a reference voltage. As a result, the comparator 320 may generate the sampling data as many times as the sampling operation is performed.

In operation S140, the receiving unit 300 may generate integrated data for each of range cells based on the plurality of sampling data. For example, the signal integrator 330 may accumulate sampling values for each of the range cells included in the plurality of sampling data to generate the integrated data for each of the range cells.

In operation S150, the receiving unit 300 may acquire noise statistical data for each of the range cells based on the integrated data for each of the range cells. For example, the statistical signal converter 340 may acquire the noise statistical data for each of the range cells based on the integrated data for each of the range cells.

In operation S160, the receiving unit 300 may perform a characteristic verification operation on the noise statistical data based on the integrated data for each of the range cells. For example, the AFE controller 350 may perform the characteristic verification operation on the noise statistical data based on the integrated data for each of the range cells.

In an embodiment, the AFE controller 350 may perform the characteristic verification operation on the noise statistical data of at least a portion of the range cells. For example, the AFE controller 350 may perform the characteristic verification operation on noise statistical data of each of the range cells within a target range.

If a result of the characteristic verification operation is a ‘fail’, in operation S170, the receiving unit 300 may adjust the number of signals being summed into the summed signal. For example, if the result of the characteristic verification operation is the ‘fail’, the AFE controller 350 may output an AFE control signal to the analog signal summing circuit 312. The analog signal summing circuit 312 may adjust the number of at least a portion of the amplified signals to be selected based on the AFE control signal. Then, the receiving unit 300 may repeatedly perform operations S120 to S150.

If the result of the characteristic verification operation is a ‘pass’, in operation S180, the receiving unit 300 may generate an extracted signal using the noise statistical data. For example, the statistical signal converter 340 may generate the extracted signal from the noise statistical data for each of the range cells.

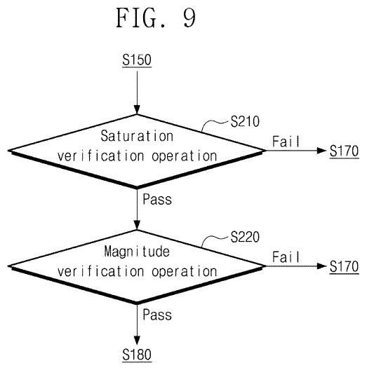

FIG. 9 illustrates an example of a characteristic verification operation, according to an embodiment of the present disclosure. Referring to FIGS. 3, 8, and 9, in operation S210, the receiving unit 300 may perform a saturation verification operation on range cells. The saturation verification operation may be performed based on whether a saturation range cell is present. For example, if there is a saturation range cell among the range cells, the AFE controller 350 may determine a result of the saturation verification operation to be a ‘fail’. If there is no saturation range cell among the range cells, the AFE controller 350 may determine the result of the saturation verification operation to be a ‘pass’.

In an embodiment, if a ratio of a first integration value Nn and a second integration value Np, which are associated with an arbitrary range cell, is less than a first threshold ratio or greater than ‘1−the first threshold ratio’, the AFE controller 350 may determine the an arbitrary range cell to be the saturation range cell. For example, if the ratio of the first integration value Nn and the second integration value Np, expressed as ‘Nn/(Nn+Np)’, is less than ‘ 1/10’ or greater than ‘ 9/10’, the AFE controller 350 may determine the arbitrary range cell to be the saturation range cell.

In an embodiment, the receiving unit 300 may perform the saturation verification operation on a portion of the range cells. For example, the receiving unit 300 may perform the saturation verification operation on the range cells of interest (hereinafter referred to as ‘target range cells’).

If the result of the saturation verification operation is the ‘fail’, the receiving unit 300 may perform operation S170. For example, if the result of the saturation verification operation is the ‘fail’, the receiving unit 300 may increase the number of signals being summed into the summed signal.

If the result of the saturation verification operation is the ‘pass’, in operation S220, the receiving unit 300 may perform a magnitude verification operation on the range cells. The magnitude verification operation may be performed based on whether a maximum signal magnitude of signals included in the range cells is equal to or less than a threshold value. For example, if the maximum signal magnitude is equal to or less than the threshold value, the AFE controller 350 may determine a result of the magnitude verification operation to be a ‘fail’. If the maximum signal magnitude is greater than the threshold value, the AFE controller 350 may determine the result of the magnitude verification operation to be a ‘pass’.

In an embodiment, if the ratio of the first integration value Nn and the second integration value Np, which are associated with the arbitrary range cell, is between a second threshold ratio and ‘1−the second threshold ratio’, the AFE controller 350 may determine that magnitude of a signal is equal to or less than the threshold value. For example, if the ratio of the first integration value Nn and the second integration value Np, expressed as ‘Nn/(Nn+Np)’, is between ‘⅖‘ and’⅗’, the AFE controller 350 may determine that the magnitude of the signal included in the arbitrary range cell is equal to or less than the threshold value.

In an embodiment, the receiving unit 300 may perform the magnitude verification operation on a portion of the range cells. For example, the receiving unit 300 may perform the magnitude verification operation on the target range cells among the range cells.

If the result of the magnitude verification operation is the ‘fail’, the receiving unit 300 may perform operation S170. For example, if the result of the magnitude verification operation is the ‘fail’, the receiving unit 300 may decrease the number of signals being summed into the summed signal.

If the result of the magnitude verification operation is the ‘pass’, the receiving unit 300 may perform operation S180.

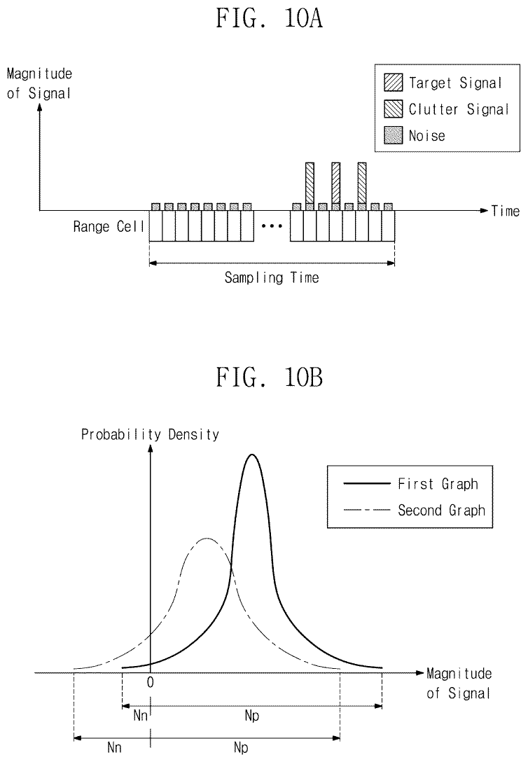

FIGS. 10A and 10B illustrate examples of a saturation verification operation, according to an embodiment of the present disclosure. FIG. 10A illustrates an extracted signal when signals included in noise statistical data are saturated, and FIG. 10B illustrates an example in which characteristics of the noise statistical data are adjusted. In FIG. 10B, a first graph represents the noise statistical data when a signal is saturated, and a second graph represents the noise statistical information when a signal is not saturated.

Referring to FIGS. 3 and 9 to 10B, when the noise statistical data is saturated, signals included in the extracted signal may not be distinguished from each other. In this case, the receiving unit 300 may adjust the characteristics of the noise statistical data such that a ratio of a first integration value Nn and a second integration value Np, expressed as ‘Nn/(Nn+Np)’, increases. That is, the receiving unit 300 may increase the number of signals that are summed into a summed signal. Thus, ‘Nn/(Nn+Np)’ may exceed a first threshold ratio.

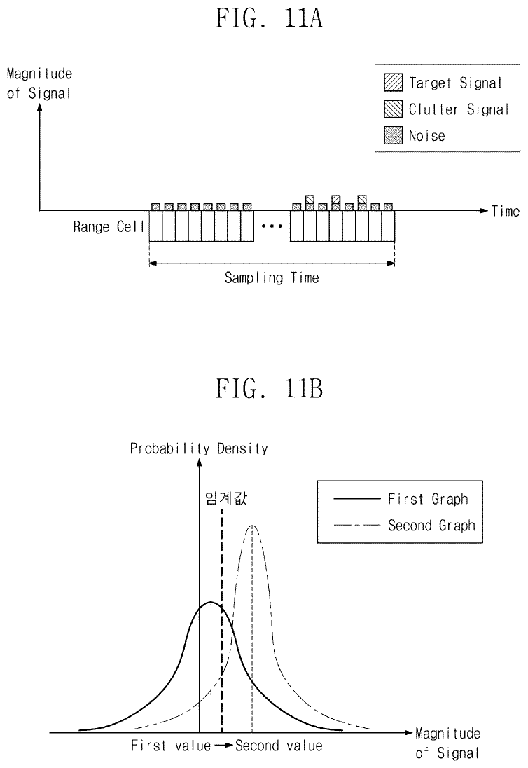

FIGS. 11A and 11B illustrate examples of a magnitude verification operation, according to an embodiment of the present disclosure. FIG. 11A illustrates an extracted signal when magnitude of signals included in noise statistical data is weak, and FIG. 11B illustrates an example in which characteristics of the noise statistical data are adjusted. In FIG. 11B, a first graph represents the noise statistical data when magnitude of a signal is weak, and a second graph represents the noise statistical information when the magnitude of the signal is sufficient.

Referring to FIGS. 3, 9, 11A, and 11B, when the magnitude of signals included in the noise statistical data is weak, the signals included in the extracted signal may not be distinguished from each other. In this case, the receiving unit 300 may adjust the characteristics of the noise statistical data so that a mean value of the noise statistical data changes from a first value to a second value. That is, the receiving unit 300 may decrease the number of signals being summed into a summed signal. Thus, the mean value of the noise statistical data may exceed a threshold value.

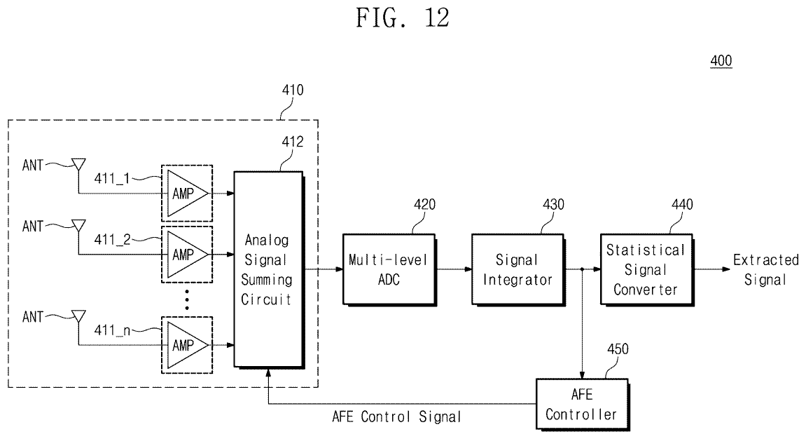

FIG. 12 illustrates a receiving unit of a radar device, according to an embodiment of the present disclosure. Referring to FIG. 12, the receiving unit 400 may include a multi-receiving circuit AFE 410, a sampling circuit 420, a signal integrator 430, a statistical signal converter 440, and an AFE controller 450.

In FIG. 12, the multi-receiving circuit AFE 410, the statistical signal converter 440, and the AFE controller 450 may correspond to the multi-receiving circuits AFE 310, statistical signal converter 340, and AFE controller 350 of FIG. 3, respectively. Therefore, redundant description is omitted for convenience of description.

The multi-level ADC 420 may repeatedly perform a sampling operation on a summed signal based on a plurality of reference voltages. For example, the multi-level ADC 420 may repeatedly perform the sampling operation on the summed signal based on first to third reference voltages. As a result, the ADC 420 may generate a plurality of sampling data as many times as the sampling operation is performed.

Each of the plurality of sampling data may include a plurality of sampling values for each of range cells. Here, the plurality of sampling values may be respectively associated with the plurality of reference voltages.

For example, when the multi-level ADC 420 performs the sampling operation based on the first to third reference voltages, the sampling data may include the sampling values for each of the range cells. The sampling values for each of the range cells may include a sampling value associated with the first reference voltage, a sampling value associated the second reference voltage, and a sampling value associated the third reference voltage.

The signal integrator 430 may generate a plurality of integrated data for the range cells based on the plurality of sampling data. That is, the signal integrator 430 may generate the integrated data for each of the range cells based on the plurality of sampling data.

The integrated data may include sampling count information and integration values for each of the range cells. For example, when the multi-level ADC 420 performs the sampling operation based on the first to third reference voltages, the integrated data may include the sampling count information and integration values N1n, N1p, N2n, N2p, N3n, and N3p for each of the range cells. The integration values N1n, N1p may be associated with the first reference voltage, the integration values N2n, N2p with the second reference voltage, and the integration values N3n, N3p with the third reference voltage.

In an embodiment, the integration values N1n, N2n, and N3n may be associated with a sampling value having a value of ‘0’, and the integration values N1p, N2p, and N3p may be associated with a sampling value having a value of ‘1’.

As described in FIG. 12, when performing the sampling operation using the multi-level ADC 420, a signal-to-noise ratio (SNR) may increase. In addition, by extracting a standard deviation of noise statistical data based on the plurality of reference voltages, characteristic of the noise statistical data may be more finely adjusted.

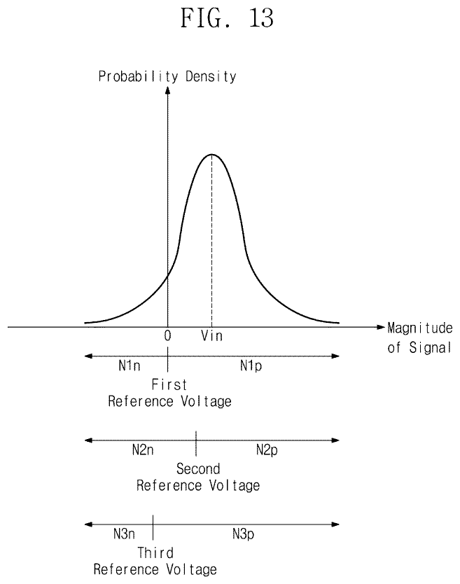

FIG. 13 illustrates noise statistical data, according to an embodiment of the present disclosure. In FIG. 13, the noise statistical data for an arbitrary range cell may be represented by a graph of a probability density function. In FIG. 13, the horizontal axis represents magnitude of a signal, and the vertical axis represents probability density.

Referring to FIGS. 12 and 13, the noise statistics graph may be acquired by accumulating sampling values for the arbitrary range cell included in a plurality of sampling data. That is, the noise statistic graph may be acquired based on integration values N1n, N1p, N2n, N2p, N3n, N3p included in integrated data for the arbitrary range cell.

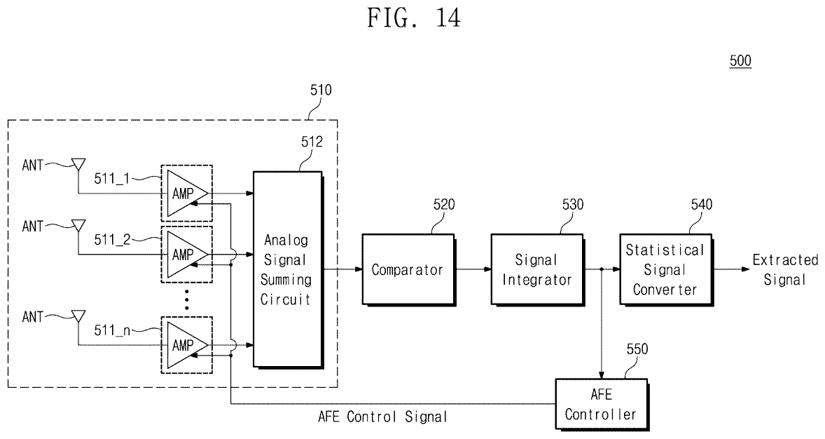

FIG. 14 illustrates a receiving unit of a radar device, according to an embodiment of the present disclosure. Referring to FIG. 14, the receiving unit 500 may include a multi-receiving circuit AFE 510, a comparator 520, a signal integrator 530, a statistical signal converter 540, and an AFE controller 550. In FIG. 14, the comparator 520, the signal integrator 530 and the statistical signal converter 540 may correspond to the comparator 320, the signal integrator 330 and the statistical signal converter 340 of FIG. 3. Therefore, redundant description is omitted for convenience of description.

The AFE controller 550 may output an AFE control signal to each of a plurality of receiving circuits 511_1 to 511_n to adjust the number of signals being summed into a summed signal. Each of the plurality of receiving circuits 511_1 to 511_n may output an amplified signal based on the AFE control signal. For example, a portion of the plurality of receiving circuits 511_1 to 511_n may output amplified signals, and the remaining portion may not output amplified signals. The number of the amplified signals output from the plurality of receiving circuits 511_1 to 511_n may be adjusted based on the AFE control signal.

The analog signal summing circuit 512 may sum the amplified signals output from the plurality of receiving circuits 511_1 to 511_n to generate the summed signal.

As described in FIG. 14, the AFE controller 550 may adjust the number of the amplified signals output from the plurality of receiving circuits 511_1 to 511_n to adjust the summed signal.

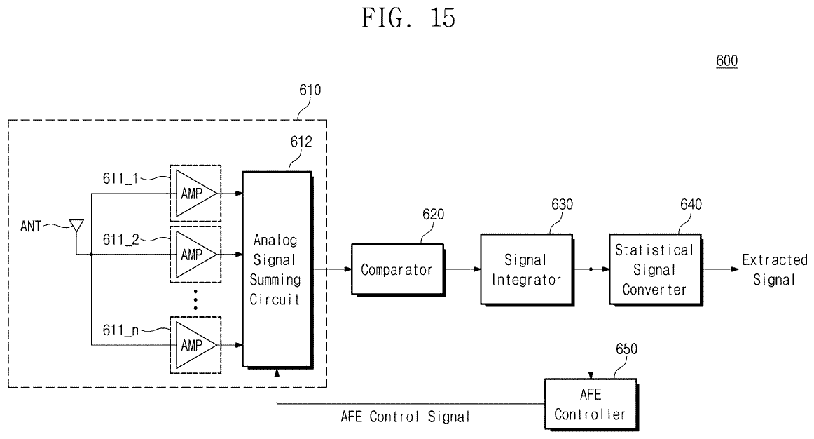

FIG. 15 illustrates a receiving unit of a radar device, according to an embodiment of the present disclosure. Referring to FIG. 15, the receiving unit 600 may include a multi-receiving circuit AFE 610, a comparator 620, a signal integrator 630, a statistical signal converter 640, and an AFE controller 650. In FIG. 15, the comparator 620, the signal integrator 630, the statistical signal converter 640 and the AFE controller 650 may correspond to the comparator 320, the signal integrator 330, the statistical signal converter 340 and the AFE controller 350 of FIG. 3. Therefore, redundant description is omitted for convenience of description.

The multi-receiving circuit AFE 610 may include a plurality of receiving circuits 611_1 to 611_n and an analog signal summing circuit 612.

Each of the plurality of receiving circuits 611_1 to 611_n may include an amplifier (AMP). The plurality of receiving circuits 6111 to 611_n may receive a received signal via single common receiving antenna. In this case, noise due to the amplifier may be reduced.

In the above embodiments, components according to the present disclosure are described by using the terms “first”, “second”, “third”, and the like. However, the terms “first”, “second”, “third”, and the like may be used to distinguish components from each other and do not limit the present disclosure. For example, the terms “first”, “second”, “third”, and the like do not involve an order or a numerical meaning of any form.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure.

According to the present disclosure, a radar device may use a statistical distribution of noise to preserve magnitude information of signals included in an echo pulse, and separately an extract signal included in the echo pulse.

According to the present invention, a radar device may facilitate signal extraction by adjusting characteristics of noise statistics.

What is claimed is:

1. A radar device comprising:
a transmitting unit configured to radiate a transmission pulse; and
a receiving unit configured to receive an echo pulse reflected from a target object,
the receiving unit includes:
a multi-receiving circuit AFE including a plurality of receiving circuits configured to amplify the echo pulse to output an amplified signals and an analog signal summing circuit configured to generate a summed signal based on the amplified signals;
a sampling circuit configured to repeatedly perform a sampling operation on the summed signal to generate a plurality of sampling data;
a signal integrator configured to generate integrated data for each of range cells based on the plurality of sampling data;
a statistical signal converter configured to acquire noise statistical data based on the integrated data, and generate an extracted signal based on the noise statistical data; and
an AFE controller configured to perform a characteristic verification operation on the noise statistical data, and adjust the summed signal based on a result of the characteristic verification operation.

2. The radar device of claim 1, wherein the characteristic verification operation includes a saturation verification operation and a magnitude verification operation on the noise statistical data.

3. The radar device of claim 2, wherein the AFE controller outputs a first AFE control signal when it is determined, as a result of the saturation verification operation, that a saturation range cell is present, and
wherein the multi-receiving circuit AFE reduces a number of signals that are summed into the summed signal based on the first AFE control signal.

4. The radar device of claim 3, wherein the AFE controller is configured to:
perform the magnitude verification operation when it is determined, as the result of the saturation verification operation, that the saturation range cell is not present; and
output a second AFE control signal when it is determined, as a result of the magnitude verification operation, that a maximum signal magnitude is equal to or less than a threshold value, and
wherein the multi-receiving circuit AFE increases the number of signals being summed into the summed signal based on the second AFE control signal.

5. The radar device of claim 1, wherein the sampling circuit includes a comparator configured to sample the summed signal based on a reference voltage,
wherein each of the plurality of sampling data includes a sampling value for each of the range cells, and
wherein the sampling value is associated with the reference voltage.

6. The radar device of claim 1, wherein the sampling circuit includes a multi-level ADC configured to sample the summed signal based on a plurality of reference voltages,
wherein each of the plurality of sampling data includes sampling values for each of the range cell, and
wherein the sampling values are respectively associated with the plurality of reference voltages.

7. The radar device of claim 1, wherein the analog signal summing circuit selects at least a portion of the amplified signals, and sums the at least the portion of the amplified signals to generate the summed signal,
wherein the AFE controller outputs an AFE control signal for adjusting the summed signal, and
wherein the analog signal summing circuit adjusts a number of the at least the portion of the amplified signals based on the AFE control signal.

8. The radar device of claim 1, wherein the AFE controller outputs an AFE control signal for adjusting the summed signal; and
wherein a number of amplified signals is adjusted based on the AFE control signal.

9. The radar device of claim 1, wherein the multi-receiving circuit AFE includes a plurality of receiving antennas, and
wherein each of the plurality of the receiving antennas is respectively connected to the plurality of receiving circuits, and is configured to receive the echo pulse.

10. The radar device of claim 1, wherein the multi-receiving circuit AFE includes a common receiving antenna, and
wherein the common receiving antenna is connected to the plurality of receiving circuits, and is configured to receive the echo pulse.

11. A method of operating a radar device for receiving an echo pulse via a plurality of receiving circuits, the method comprising:
amplifying the echo pulse to output a plurality of amplified signals;
generating a summed signal based on the plurality of amplified signals;
performing a sampling operation on the summed signal repeatedly to generate a plurality of sampling data;
generating integrated data for each of range cells based on the plurality of sampling data;
acquiring noise statistical data based on the integrated data;
performing a characteristic verification operation on the noise statistical data; and
adjusting a number of signals being summed into the summed signal based on a result of the characteristic verification operation.

12. The method of claim 11, wherein the performing of the characteristic verification operation on the noise statistical data includes:
performing a saturation verification operation on the noise statistical data; and
performing a magnitude verification operation on the noise statistical data when it is determined, as a result of the saturation verification operation, that a saturation range cell is not present.

13. The method of claim 12, wherein the adjusting of the number of signals being summed into the summed signal includes decreasing the number of signals being summed into the summed signal when it is determined, as the result of the saturation verification operation, that the saturation range cell is present.

14. The method of claim 13, wherein the adjusting of the number of signals being summed into the summed signal includes increasing the number of signals being summed into the summed signal when it is determined, as a result of the magnitude verification operation, that a maximum signal magnitude is equal to or less than a threshold value.

15. The method of claim 11, wherein the sampling operation is performed based on a reference voltage,
wherein each of the plurality of sampling data includes a sampling value for each of the range cells, and
wherein the sampling value is associated with the reference voltage.

16. The method of claim 11, wherein the sampling operation is performed based on a plurality of reference voltages,
each of the plurality of sampling data includes sampling values for each of the range cells, and
wherein the sampling values are respectively associated with the plurality of reference voltages.

17. The method of claim 11, wherein the generating of the summed signal based on the plurality of amplified signals includes:
selecting at least a portion of the plurality of amplified signals; and
summing the at least the portion of the plurality of amplified signals to generate the summed signal, and
wherein the adjusting of the number of signals being summed into the summed signal includes adjusting the number of the at least the portion of the plurality of amplified signals.

18. The method of claim 11, wherein the adjusting of the number of signals being summed into the summed signal includes adjusting the number of the plurality of amplified signals being output.

19. The method of claim 11, further comprising:
generating an extracted signal using the noise statistical data based on the result of the characteristic verification operation.

20. The method of claim 11, wherein the radar device receives the echo pulse via at least one of receiving antennas.
